(19) United States
(12) Patent Application Publication
(10) Pub. No.: US 2026/0356006 A1
(43) Pub. Date: Nov. 12, 2026

(54) DIGITAL FABRICATION OF COMPLEX SURFACES THROUGH ACTUATED MODULAR PNEUMATICS

(71) Applicant: University of Virginia Patent Foundation, Charlottesville, VA (US)

(72) Inventors: Kyle Schumann, Charlottesville, VA (US); Katherine MacDonald, Charlottesville, VA (US)

(21) Appl. No.: 19/125,007

(22) PCT Filed: Nov. 3, 2023
(86) PCT No.: PCT/US2023/078585

§ 371 Date: Apr. 28, 2025

Related U.S. Application Data
(60) Provisional application No. 63/422,050, filed on Nov. 3, 2022.

(51) Int. Cl. B28B 17/00; B23Q 1/03; B28B 7/02; B28B 7/06

(52) U.S. Cl. CPC B28B 17/0081; B23Q 1/03; B28B 7/025; B28B 7/06

(57) ABSTRACT

Surfaces can be modeled using increasingly powerful digital modeling and fabrication tools applied to the creation of molds or formwork for cast or formed materials. Many of these processes are highly customizable but resource intensive, singular in geometry, and disposable. Examples herein introduce pillow forming as a customizable, reusable forming system aimed at minimizing the resource intensity of construction and capable of producing both standardized and unique curved molded panels. The apparatus comprises a field or grid of pneumatic pillows that inflate to form a complex curved surface with which various materials can be formed or cast.

### CROSS-REFERENCE TO RELATED APPLICATION

This application claims the benefit of and priority to U.S. Provisional Patent Application No. 63/422,050 filed on 3 Nov. 2022, entitled “Pillow Forming: Digital Fabrication of Complex Surfaces through Actuated Modular Pneumatics” the contents of which are incorporated by reference in their entirety herein.

### BACKGROUND

The state of the art has seen development of increasingly powerful digital modeling and fabrication tools applied to the creation of molds or formwork for cast or formed materials. Many of these processes are highly customizable but resource intensive, singular in geometry, and disposable.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates a block diagram according to examples of the disclosure.

FIG. 2 illustrates a block diagram according to examples of the disclosure.

FIG. 3 illustrates a block diagram according to examples of the disclosure.

FIG. 4 illustrates a block diagram according to examples of the disclosure.

FIG. 5 illustrates a block diagram according to examples of the disclosure.

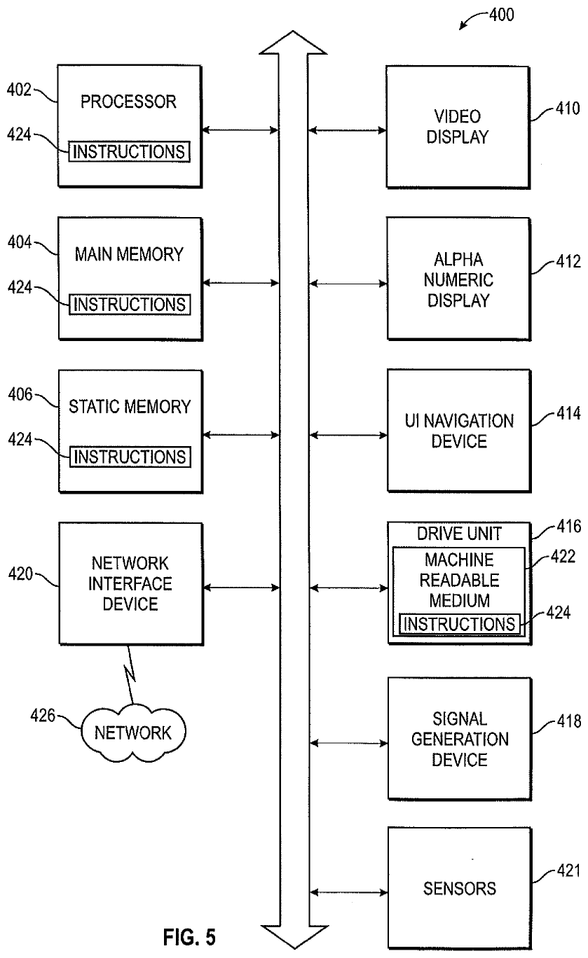

### DETAILED DESCRIPTION

Disclosed herein are various embodiments for pillow forming as a customizable, reusable forming system aimed at minimizing the resource intensity of construction and capable of producing both standardized and unique curved molded panels. Examples of the disclosure comprise a field of pneumatic pillows that inflate to form a complex curved surface with which various materials can be formed or cast. The design and construction of the system is discussed, including the modular inflation system, pneumatic and electronic control systems, control software run through Rhinoceros, Grasshopper, Arduino, and other software systems, as well as the standard operation procedure. Examples of the disclosure can be demonstrated through production of an architectural installation or other construction projects. Various limitations and opportunities of the system are discussed and analyzed, and opportunities for future development and applications in sustainable construction are posited.

Computer-aided industrial manufacturing has seen the proliferation and refinement of automated approaches to both subtractive and additive manufacturing, resulting in the viability of constructing customizable, complex forms in a variety of materials. Examples of the disclosure address the limitations of current widespread molding processes by proposing an automated method for reformable molds. The fabrication of molds typically relies on subtractive processes such as CNC milling, foam cutting, and carving of EPS, MDF, and other petroleum-and wood-based materials, with each mold used to produce only a single unique geometry. This results in waste throughout the fabrication process: offcuts are produced in the creation of each mold, multiple molds must be produced for non-repeating geometries, and because mold geometries are fixed, they cannot be reused for subsequent construction projects, leading to their disposal. This waste of valuable resources and the environmental impacts associated with disposal create a need for molding techniques which are reusable rather than disposable.

The need for reusable molding materials has been explored for both the production of repeating and customizable forms, resulting in a number of new formwork materials: fabric (West 2016; Chandler and Keable 2009); sand (Anne Holtrop's Green Corner Building); earth (Ensamble Studio's Truffle House and Structures of Landscape for Tippet Rise Art Center); and even ice (Sitnikov et al. 2019). Each of these techniques leverages materials which are both easier to obtain locally and to reform than typical petroleum-and wood-based materials, reducing the environmental impact of these processes and offering new aesthetic effects in the cast output.

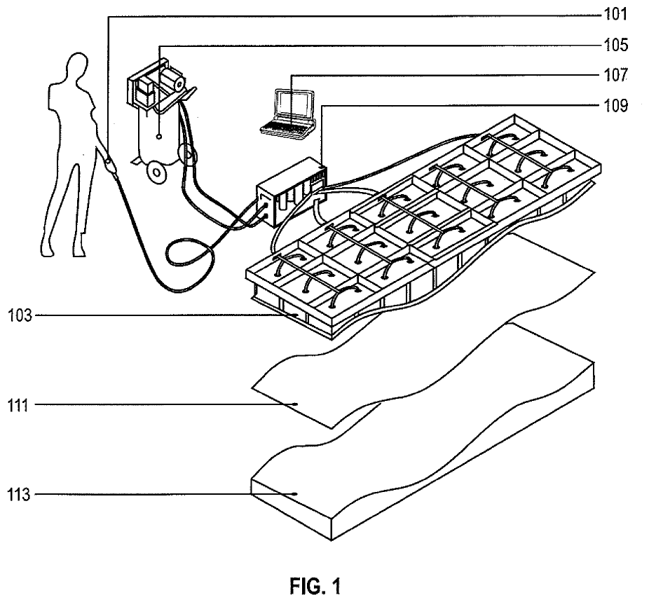

Building on such work, pillow forming, the ground-up, modular forming system described herein, preferences variable over repetitious form, allowing for the production of serial unique forms through a malleable process—the injection and removal of air—therefore eliminating the waste intrinsic to standard means of mold production (FIG. 1). Because the inflation process is reversible, repeatable, and adaptable to various surface geometries, many different forms can be molded without the need for multiple molds, effectively avoiding the creation of disposable molds and the offcuts associated with their production. A key advancement of this system is its modularity: pillow forming is composed of a field of pneumatic units (pillows) that are individually operated. The modular nature of the system means that it is scalable, overcoming physical limitations such as CNC bed size, robotic arm reach, and others presented by typical mold production equipment. Pillow formed wall or ceiling panels can also be assembled edge-to-edge, producing continuous surfaces many times larger than the apparatus itself, without using any additional material except that which constitutes the finished product.

Aiming to address the challenge of creating customized formwork, examples of the disclosure build upon aspects of three categories of technology: actuated surfaces, malleable forming, and adaptable formwork.

### Actuated Surfaces

A modular surface, composed of a grid of individually operated units, is a strategy explored in shape changing interfaces such as inFORM, developed at the MIT Tangible Media Group (Leithinger et al. 2015). In examples of this disclosure, a surface is physically modeled by individually actuated pixels. The calibration of movement of each pixel to create a single continuous global surface is achieved through control software. While inFORM is applied as a physical display surface, its creation of an actuated, reformable pixel-based system shares similarities to the customizable molding system described herein.

Other methods for controlled actuated surfaces can be utilized using textiles to program various surface deformations and curvatures. Knitflatable and PneumaKnit each explore the programing of geometry into knitwork which is inflated, producing controlled forms (Baranovskaya et al. 2016; Ahlquist et al. 2017). In these projects, emphasis is placed on the design of a knit pattern that inflates into a specific three-dimensional geometry, while the actuation itself consists of only three fixed states (inflated, partially inflated, deflated) rather than variable geometries. More similar in approach to inFORM are Barkow Leibinger's Kinetic Wall and Asif Khan's Mega Faces. Both were exhibited as large-scale architectural surfaces in 2014 and employ actuated pistons to map three-dimensional data across reformable fabric surfaces.

### Malleable Forming

In the area of malleable forming, material is not subtracted (CNC milling), or added (3D printing), but physically manipulated, often through some combination of pressure and/or heat.

Incremental sheet metal forming creates three-dimensional surfaces through the application of pressure along a toolpath, gradually deforming a growing area of the sheet metal. Such processes have been applied using robotic arms and a sturdy clamping apparatus (Kalo and Newsum 2014). While such examples of incremental sheet forming are conceived as final outputs, it is feasible that the resulting surfaces could be used as molds. However, the incremental toolpath necessary would require a long production time, and there would likely be a limit on the degree to which the sheet could be reformed depending on material ductility.

Several projects reimagine plastic thermoforming operations, abandoning the traditional physical mold for a pressure chamber under the surface to be thermoformed (Mueller et al. 2019). Selective robotic heating makes the surface malleable, while positive or negative air pressure deforms it up or down. It is possible to apply the thermoforming method to create reformable molds, though like incremental sheet metal forming, the degree to which the sheet can be reformed would likely be limited.

### Adaptable Formwork

Molds can also be created from reformable or reconfigurable materials. Pneumatic formwork has been explored in several projects at ICD Stuttgart, in which inflatable volumes are used to create voids within an assembly of granular aggregate units, or as a scaffold on which a robotically applied fiber composite surface can be constructed (Rusenova et al. 2016; Vasey et al. 2015). These projects can involve pneumatic surfaces against which material is molded or placed; however, the inflated forms are fixed in geometry, and must be reconfigured manually rather than through programmable actuation.

In several P_Wall projects by Matsys, an adaptable formwork is created by positioning a series of dowels in a field condition and draping them with a stretchable fabric surface onto which plaster is cast (Kudless 2011). The molds are manually reconfigurable, and the resultant forms are a negotiation between dowel placement and the sagging of fabric under the weight of the plaster.

Zero Waste Free-Form Formwork, similarly explores reconfigurable formwork for material molding, but works to overcome material irregularities with a robotically positioned surface (Oesterle et al. 2012). A robotic arm is used to manipulate a series of linear pistons arrayed to scaffold a flexible surface. This surface is used to produce a wax mold for concrete casting in a lost wax process. The repositionable surface and recycling of wax similarly reduce material waste in the mold making process. While the ambitions of pillow forming are perhaps most closely aligned with this technique, a principal difference in approach taken with pillow forming is a shift to a standalone system that does not rely on a robotic arm to accurately position the surface, enabling mold surfaces larger than the arm's reach to be created.

Zero Waste Free-Form Formwork proposes a closed-loop material cycle, in which the wax used to produce one mold is melted down and formed into the next. Similarly, IceFormwork creates cast concrete elements using blocks of ice CNC milled in a subtractive process as molds (Sitnikov et al. 2019). The creation of an ice mold that can be cast upon, melted, refrozen, milled, and cast upon again demonstrates the possibilities for a formwork materiality that is easy to source, demold, and reuse. Pillow forming also proposes a closed-loop material cycle, but instead eliminates the need for mold material to be recycled by casting directly on an actuated surface.

Reference is now made to FIG. 1 which illustrates an environment according to examples of the disclosure. Pillow forming is demonstrated through the construction of a fully functional apparatus used to fabricate an architectural installation. The apparatus consists of a physical inflation system, pneumatic control system, electronic control system, and control software. These systems are described herein, along with the typical operation procedure. As shown in FIG. 1 a control pendant 101 can allow a user to control the inflation process of a pillow grid 103. The pillow grid 103 can be installed with a first side on a rigid backing so as to allow for a second and opposing side to be inflated as described herein. An air compressor 105 can provide a source of air or other gas that can be utilized to inflate the pillow grid 103. A computer 107 running control software can control the inflation process as well as specify the amount of air pressure that should be provided to each pillow within the pillow grid 103. Pneumatic and electronic control systems 109 can interface with the control pendant 101, air compressor 105, the pillow grid 103 and/or the computer 107 to facilitate providing air pressure to the pillow grid 103. The second and opposing side of the pillow grid 103 can face a flexible sheet, such as rubber sheet 111.

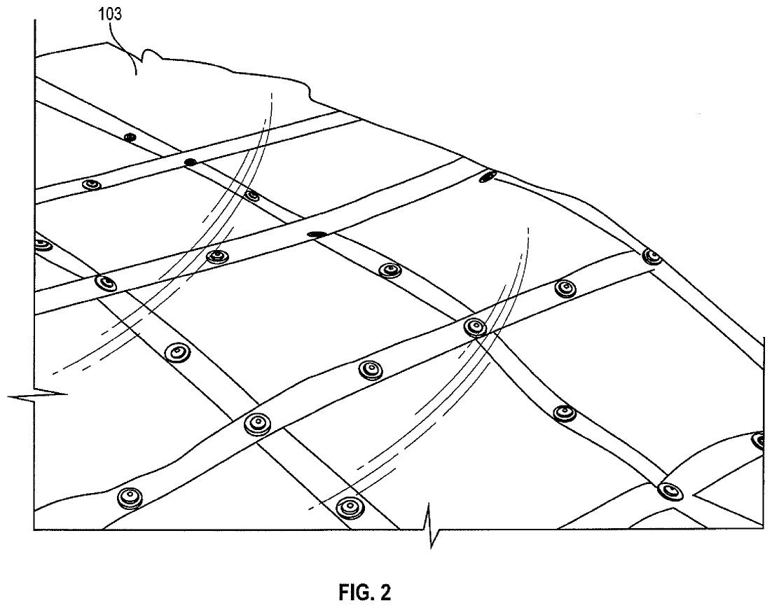

The rubber sheet 111 can be placed between the pillow grid 103 and the material to be formed, denoted by material 113. The physical inflation system can comprise a rigid surface, such as a plywood waffle grid on which a grid of cubic or cuboid inflatable pillows can be mounted. The cubic inflatable pillows can be one foot cubes. The pillows can be made of clear vinyl sheet, which can be reinforced through mechanically sewn seams and made airtight. For example a vinyl adhesive can be applied over these seams. Each pillow can be inflated independently, expanding as it fills with air. Each pillow can have an extra strip of material along the perimeter of the top and bottom faces with which the pillows are attached to each other and to the rigid backing. Attaching the pillows to each other at the corners and midpoints of the top edges allows for a continuous or semi-continuous surface to be maintained regardless of discrepancies between inflation heights or air pressures applied to neighboring pillows, which is shown in FIG. 2. Any number of pillows can be utilized in the pillow grid 103 to achieve various final dimensions of the apparatus. For example, a final large scale apparatus measures 3 feet by 10 feet by utilizing thirty individual pillows that are 1 foot cubic in dimension, but other dimensions of the final apparatus and the individual pillows can be utilized.

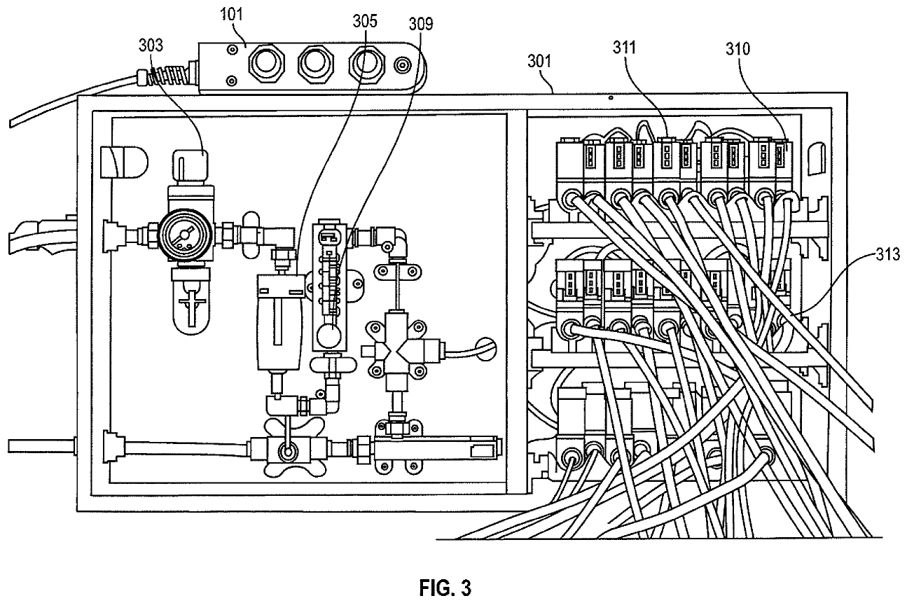

Pneumatic Control System—The pneumatic system 300, as shown in FIG. 3, can comprise an air compressor, attached with air hoses to a pneumatic control system. Air coming from the compressor can be first run through a filter regulator 303 and a desiccant air dryer filter 305 to remove moisture and prevent condensation from building up in the hoses and pillows. Air can then be run through a flowmeter 309 with a range of 0.4 to 4 standard cubic feet per minute (scfm) that allows the airflow to be precisely controlled, which can be important for calibrating pillow inflation, as discussed further below.

Next, a series of manifolds that can be arranged in a manifold array 311, can split the line into individual air supply hoses, each operated by an electronic solenoid valve 310 controlling a single pillow. An air supply hose 313 can be connected to a single pillow from the pillow grid 103. Push-to-connect fittings can be used throughout to enable easy replacement or reconfiguration of parts.

A pair of valves that can be manually operated allows the user to switch between inflation and deflation modes. When switched to deflation mode, the compressed air can be run directly through a venturi valve, generating vacuum and allowing the pillows to be emptied at the end of each inflation cycle.

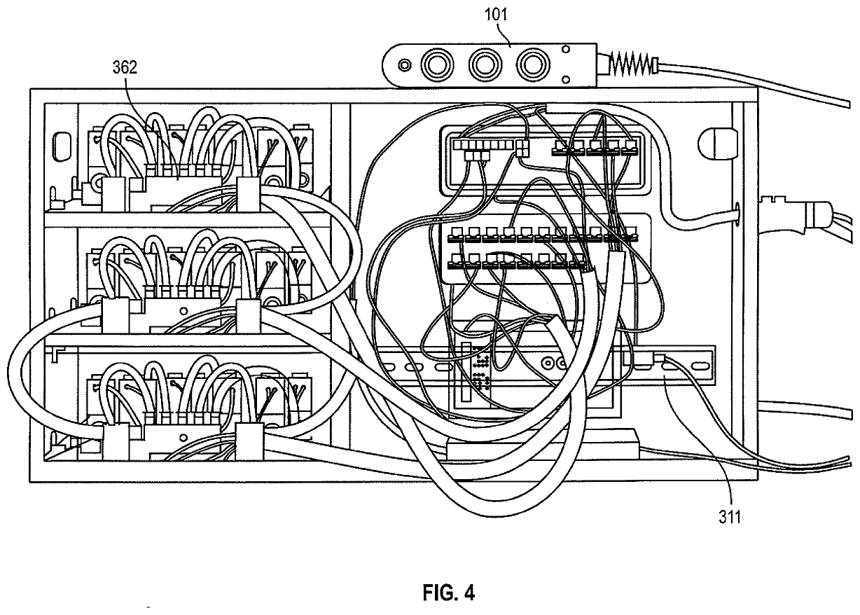

Electronic Control System. The pneumatic system 300 can be controlled via software running on a computing device 311, such as with an Arduino Mega, which can provide enough digital output pins to wire solenoid valves, one to control each pillow as is shown in FIG. 4. The solenoid valves can be provided in one or more solenoid manifold array 362. The solenoid valves can each be 12 v, so a separate power source can be utilized used to convert 120 v AC or 240 v AC to 12 v DC. In one implementation, the Arduino operates at 5 v, powered via USB from a computer, which is also used to prepare and upload the control software and monitor the system during use.

A control pendant 101 houses three push-button switches, the operation of which is described in the following section, as well as a small indicator light which will be illuminated if the Arduino is powered and successfully running the uploaded program.

The pneumatic system 300 can be operated beginning with a Rhinoceros model. Once the user has digitally modeled the desired surface, it is input through a script that analyzes the surface and converts the surface height to inflation times for each individual pillow in the pillow grid 303.

In the script, the input surface can be divided into a grid corresponding with the size of the pillows. The average height of each pillow can be calculated by measuring the height at intervals every two inches and dividing by the total number of measurements.

Once the average pillow height is found, it is converted to an inflation time for each pillow. To determine this conversion, a series of inflation tests were conducted using a single pillow. With an input flow rate of 1 scfm, the pillow was repeatedly inflated, increasing the inflation time by one-second intervals. It was determined that the pillow height increased at a fairly constant rate of one inch per second of inflation time, resulting in a straightforward conversion of pillow height to inflation time: average height (in inches) multiplied by 1000 to achieve the desired units of milliseconds.

These millisecond time values for each pillow are compiled into device-ready code using a series of concatenate components, producing a text panel which is can be directly provided into a script executed by the computing device 311. This can be accomplished automatically or manually, but the manual step of copying the values to the script can afford the user an opportunity to verify that the input surface was read correctly and that there are no null or otherwise extreme values. Once the values are pasted into the prepared code, it is uploaded to the machine via an I/O interface to the computing device 311.

The pneumatic system 300 is operated through a pair of aforementioned manual valves to switch between positive and negative pressure air supply, and a control pendant with three physical push-button switches that begin the inflation sequence, run a vacuum sequence to deflate all pillows, or cancel the currently running operation.

A digital readout can be provided on the computing device. This readout can provide reminders for the operator to manually switch the air supply from positive to negative pressure when beginning the inflation or vacuum sequences and provides values for inflation/vacuum times for each pillow and a total time value at the conclusion of each sequence.

When the operator has uploaded code and is ready to begin, a button on the control pendant 101 can be pressed to initiate the inflation sequence, and a reminder is provided to manually switch to the positive pressure air supply. Once this is done, a second press of the button can begin inflation, with times provided on screen as each pillow inflates, until the inflation sequence is complete. The process for deflation is very similar but using another button on the control pendant 101, and another button can be used at any time to stop the current process. Stopping the process can function as a hard reset on the Arduino, which maintains the current software upload but means that the interrupted sequence needs to be restarted from the beginning.

Once the inflation sequence is complete, the surface is ready to be used for forming or casting. Since the solenoid valves operating the pillows are closed when unpowered, the apparatus can hold its form for many hours, and may eventually deform due to any small air leaks that may exist in the seams of the pillows. This is true even if it is disconnected from the air supply, electrical power, or the control computer, any of which can be done to make it easier to manipulate the apparatus as needed for forming or casting.

Pillow forming can be demonstrated in the translation of digitally modeled undulating surfaces into physical molds and formed architectural wall panels. Pillow forming is conceived as a low-waste, reusable mold for sustainable construction.

The pillows can be inflated with particular sequencing. Before the inflation sequence is run, the pillows can be deflated with vacuum, and since the solenoid valves are closed, they are held fully deflated. If the first pillow is inflated to its full amount immediately, the neighboring deflated pillows will prevent it from expanding, and the resulting tension can rip the pillows apart at their connections. To prevent this, the pillows can be inflated evenly a bit at a time. This can be accomplished by opening all solenoids at once and closing them as needed, but the rate of air flow into the pillows can be different depending on how many solenoids are open at any given time. Instead, the inflation time for each pillow is divided by 3, and the pillows are all inflated to one third of their final height, then another third, then fully inflated. This produces a more gradual rising between adjacent pillows and excessive stress is mitigated.

The surface physically formed by the pillow forming apparatus can accommodate a range of possible curvatures that are limited by the ways in which any given pillow geometry can move. The surfaces are essentially 2.5-dimensional in definition, as no cantilevers or fold overs are possible. The surface must be smooth and continuous given the attachment of the pillows to one another, producing a single surface. If the pillows were to be selectively detached at their tops, steps in the surface could be achievable. The resolution or degree of undulation possible in the surface is related to the area of the pillows, constructed in a 1 foot by 1 foot grid. Narrower pillows with smaller surface areas can be used to produce more tightly undulating surfaces, as discussed in the following section.

Variations in the design and aggregation of the pneumatic pillows have the potential to alter the range of possible inflated surfaces. Changing the current square grid of pillows to a triangular, hexagonal, or other grid could smooth transitions across the surface in different ways. Altering the height of the fully inflated pillow, or its internal structure—several stacked or interconnected bladders instead of one large volume, for example—would affect how the pillows inflate and rise, and how much weight they can support. Such iterations will be developed and tested in future work.

The ability to create a complex physical surface from a digital model accurately and with a reusable system creates opportunities for fabrication in a variety of materials. While the pillow forming apparatus is tested in the production of a small installation, scaling the molding process toward a more traditional architectural application such as facade paneling is conceivable. In the demonstrated application, material is formed through compression by the pillow forming apparatus. Future work will explore alternative material strategies, including surface-applied materials such as fiberglass and shotcrete, and cast materials such as concrete and plaster. While cast materials will present a few challenges in terms of adding temporary sides around the pillow forming apparatus to create a sealed, castable mold, the ability to accurately form complex three-dimensional surfaces, either repeatable or unique, suggests that it would be possible to mold panels that can be added together to create large and continuous surfaces. Such applications might include custom wall or ceiling paneling or unique tilt-up concrete wall slabs.

Pillow forming advances techniques of adaptable formwork, toward the larger aim of minimizing the resource intensity of construction—in particular, custom mold production. While the materials against which molded materials are formed have typically been costly and petroleum- or wood-based, the forming system described in this paper demonstrates the potential of air as an economical material that does not need to be harvested, refined, stored, or transported. In contrast to the fixed, heavy, disposable molds typical of construction, the pillow forming apparatus is light, reformable, and highly customizable.

Although example embodiments of the present disclosure are explained in some instances in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It should be appreciated that any of the components or modules referred to with regards to any of the present invention embodiments discussed herein, may be integrally or separately formed with one another. Further, redundant functions or structures of the components or modules may be implemented. Moreover, the various components may be communicated locally and/or remotely with any user/operator/customer/client or machine/system/computer/processor. Moreover, the various components may be in communication via wireless and/or hardwire or other desirable and available communication means, systems and hardware. Moreover, various components and modules may be substituted with other modules or components that provide similar functions.

It should be appreciated that the device and related components discussed herein may take on all shapes along the entire continual geometric spectrum of manipulation of x, y and z planes to provide and meet the environmental, anatomical, and structural demands and operational requirements. Moreover, locations and alignments of the various components may vary as desired or required.

It should be appreciated that various sizes, dimensions, contours, rigidity, shapes, flexibility and materials of any of the components or portions of components in the various embodiments discussed throughout may be varied and utilized as desired or required.

It should be appreciated that while some dimensions are provided on the aforementioned figures, the device may constitute various sizes, dimensions, contours, rigidity, shapes, flexibility and materials as it pertains to the components or portions of components of the device, and therefore may be varied and utilized as desired or required.

It must also be noted that, as used in the specification and the appended claims, the singular forms “a,” “an” and “the” include plural referents unless the context clearly dictates otherwise. Ranges may be expressed herein as from “about” or “approximately” one particular value and/or to “about” or “approximately” another particular value. When such a range is expressed, other exemplary embodiments include from the one particular value and/or to the other particular value.

By “comprising” or “containing” or “including” is meant that at least the named compound, element, particle, or method step is present in the composition or article or method, but does not exclude the presence of other compounds, materials, particles, or method steps, even if the other such compounds, material, particles, or method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

Some references, which may include various patents, patent applications, and publications, are cited in a reference list and discussed in the disclosure provided herein. The citation and/or discussion of such references is provided merely to clarify the description of the present disclosure and is not an admission that any such reference is “prior art” to any aspects of the present disclosure described herein. In terms of notation, “[n]” corresponds to the nth reference in the list. All references cited and discussed in this specification are incorporated herein by reference in their entireties and to the same extent as if each reference was individually incorporated by reference.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g. 1 to 5 includes 1, 1.5, 2, 2.75, 3, 3.90, 4, 4.24, and 5). Similarly, numerical ranges recited herein by endpoints include subranges subsumed within that range (e.g. 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

In summary, while the present invention has been described with respect to specific embodiments, many modifications, variations, alterations, substitutions, and equivalents will be apparent to those skilled in the art. The present invention is not to be limited in scope by the specific embodiment described herein. Indeed, various modifications of the present invention, in addition to those described herein, will be apparent to those of skill in the art from the foregoing description and accompanying drawings. Accordingly, the invention is to be considered as limited only by the spirit and scope of the disclosure (and claims) including all modifications and equivalents.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application. For example, regardless of the content of any portion (e.g., title, field, background, summary, abstract, drawing figure, etc.) of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Unless clearly specified to the contrary, there is no requirement for any particular described or illustrated activity or element, any particular sequence or such activities, any particular size, speed, material, dimension or frequency, or any particularly interrelationship of such elements. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all sub ranges therein. Any information in any material (e.g., a United States/foreign patent, United States/foreign patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

FIG. 4 is a block diagram illustrating an example of a machine upon which one or more aspects of embodiments of the present invention can be implemented.

Referring to FIG. 4, an aspect of an embodiment of the present invention includes, but not limited thereto, a system, method, and computer readable medium that provides: digital fabrication of complex surfaces through actuated modular pneumatics using pillow formation, which illustrates a block diagram of an example machine 400 upon which one or more embodiments (e.g., discussed methodologies) can be implemented (e.g., run).

Examples of machine 400 can include logic, one or more components, circuits (e.g., modules), or mechanisms. Circuits are tangible entities configured to perform certain operations. In an example, circuits can be arranged (e.g., internally or with respect to external entities such as other circuits) in a specified manner. In an example, one or more computer systems (e.g., a standalone, client or server computer system) or one or more hardware processors (processors) can be configured by software (e.g., instructions, an application portion, or an application) as a circuit that operates to perform certain operations as described herein. In an example, the software can reside (1) on a non-transitory machine readable medium or (2) in a transmission signal. In an example, the software, when executed by the underlying hardware of the circuit, causes the circuit to perform the certain operations.

In an example, a circuit can be implemented mechanically or electronically. For example, a circuit can comprise dedicated circuitry or logic that is specifically configured to perform one or more techniques such as discussed above, such as including a special-purpose processor, a field programmable gate array (FPGA) or an application-specific integrated circuit (ASIC). In an example, a circuit can comprise programmable logic (e.g., circuitry, as encompassed within a general-purpose processor or other programmable processor) that can be temporarily configured (e.g., by software) to perform the certain operations. It will be appreciated that the decision to implement a circuit mechanically (e.g., in dedicated and permanently configured circuitry), or in temporarily configured circuitry (e.g., configured by software) can be driven by cost and time considerations.

Accordingly, the term “circuit” is understood to encompass a tangible entity, be that an entity that is physically constructed, permanently configured (e.g., hardwired), or temporarily (e.g., transitorily) configured (e.g., programmed) to operate in a specified manner or to perform specified operations. In an example, given a plurality of temporarily configured circuits, each of the circuits need not be configured or instantiated at any one instance in time. For example, where the circuits comprise a general-purpose processor configured via software, the general-purpose processor can be configured as respective different circuits at different times. Software can accordingly configure a processor, for example, to constitute a particular circuit at one instance of time and to constitute a different circuit at a different instance of time.

In an example, circuits can provide information to, and receive information from, other circuits. In this example, the circuits can be regarded as being communicatively coupled to one or more other circuits. Where multiple of such circuits exist contemporaneously, communications can be achieved through signal transmission (e.g., over appropriate circuits and buses) that connect the circuits. In embodiments in which multiple circuits are configured or instantiated at different times, communications between such circuits can be achieved, for example, through the storage and retrieval of information in memory structures to which the multiple circuits have access. For example, one circuit can perform an operation and store the output of that operation in a memory device to which it is communicatively coupled. A further circuit can then, at a later time, access the memory device to retrieve and process the stored output. In an example, circuits can be configured to initiate or receive communications with input or output devices and can operate on a resource (e.g., a collection of information).

The various operations of method examples described herein can be performed, at least partially, by one or more processors that are temporarily configured (e.g., by software) or permanently configured to perform the relevant operations. Whether temporarily or permanently configured, such processors can constitute processor-implemented circuits that operate to perform one or more operations or functions. In an example, the circuits referred to herein can comprise processor-implemented circuits.

Similarly, the methods described herein can be at least partially processor-implemented. For example, at least some of the operations of a method can be performed by one or processors or processor-implemented circuits. The performance of certain of the operations can be distributed among the one or more processors, not only residing within a single machine, but deployed across a number of machines. In an example, the processor or processors can be located in a single location (e.g., within a home environment, an office environment or as a server farm), while in other examples the processors can be distributed across a number of locations.

The one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., Application Program Interfaces (APIs).)

Example embodiments (e.g., apparatus, systems, or methods) can be implemented in digital electronic circuitry, in computer hardware, in firmware, in software, or in any combination thereof. Example embodiments can be implemented using a computer program product (e.g., a computer program, tangibly embodied in an information carrier or in a machine readable medium, for execution by, or to control the operation of, data processing apparatus such as a programmable processor, a computer, or multiple computers).

A computer program can be written in any form of programming language, including compiled or interpreted languages, and it can be deployed in any form, including as a stand-alone program or as a software module, subroutine, or other unit suitable for use in a computing environment. A computer program can be deployed to be executed on one computer or on multiple computers at one site or distributed across multiple sites and interconnected by a communication network.

In an example, operations can be performed by one or more programmable processors executing a computer program to perform functions by operating on input data and generating output. Examples of method operations can also be performed by, and example apparatus can be implemented as, special purpose logic circuitry (e.g., a field programmable gate array (FPGA) or an application-specific integrated circuit (ASIC)).

The computing system can include clients and servers. A client and server are generally remote from each other and generally interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware can be a design choice. Below are set out hardware (e.g., machine 400) and software architectures that can be deployed in example embodiments.

In an example, the machine 400 can operate as a standalone device or the machine 400 can be connected (e.g., networked) to other machines.

In a networked deployment, the machine 400 can operate in the capacity of either a server or a client machine in server-client network environments. In an example, machine 400 can act as a peer machine in peer-to-peer (or other distributed) network environments. The machine 400 can be a personal computer (PC), a tablet PC, a set-top box (STB), a Personal Digital Assistant (PDA), a mobile telephone, a web appliance, a network router, switch or bridge, or any machine capable of executing instructions (sequential or otherwise) specifying actions to be taken (e.g., performed) by the machine 400. Further, while only a single machine 400 is illustrated, the term “machine” shall also be taken to include any collection of machines that individually or jointly execute a set (or multiple sets) of instructions to perform any one or more of the methodologies discussed herein.

Example machine (e.g., computer system) 400 can include a processor 402 (e.g., a central processing unit (CPU), a graphics processing unit (GPU) or both), a main memory 404 and a static memory 406, some or all of which can communicate with each other via a bus 408. The machine 400 can further include a display unit 410, an alphanumeric input device 412 (e.g., a keyboard), and a user interface (UI) navigation device 411 (e.g., a mouse). In an example, the display unit 810, input device 417 and UI navigation device 414 can be a touch screen display. The machine 400 can additionally include a storage device (e.g., drive unit) 416, a signal generation device 418 (e.g., a speaker), a network interface device 420, and one or more sensors 421, such as a global positioning system (GPS) sensor, compass, accelerometer, or other sensor.

The storage device 416 can include a machine readable medium 422 on which is stored one or more sets of data structures or instructions 424 (e.g., software) embodying or utilized by any one or more of the methodologies or functions described herein. The instructions 424 can also reside, completely or at least partially, within the main memory 404, within static memory 406, or within the processor 402 during execution thereof by the machine 400. In an example, one or any combination of the processor 402, the main memory 404, the static memory 406, or the storage device 416 can constitute machine readable media.

While the machine readable medium 422 is illustrated as a single medium, the term “machine readable medium” can include a single medium or multiple media (e.g., a centralized or distributed database, and/or associated caches and servers) that configured to store the one or more instructions 424. The term “machine readable medium” can also be taken to include any tangible medium that is capable of storing, encoding, or carrying instructions for execution by the machine and that cause the machine to perform any one or more of the methodologies of the present disclosure or that is capable of storing, encoding or carrying data structures utilized by or associated with such instructions. The term “machine readable medium” can accordingly be taken to include, but not be limited to, solid-state memories, and optical and magnetic media. Specific examples of machine readable media can include non-volatile memory, including, by way of example, semiconductor memory devices (e.g., Electrically Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

The instructions 424 can further be transmitted or received over a communications network 426 using a transmission medium via the network interface device 420 utilizing any one of a number of transfer protocols (e.g., frame relay, IP, TCP, UDP, HTTP, etc.). Example communication networks can include a local area network (LAN), a wide area network (WAN), a packet data network (e.g., the Internet), mobile telephone networks (e.g., cellular networks), Plain Old Telephone (POTS) networks, and wireless data networks (e.g., IEEE 802.11 standards family known as Wi-Fi®, IEEE 802.16 standards family known as WiMax®), peer-to-peer (P2P) networks, among others. The term “transmission medium” shall be taken to include any intangible medium that is capable of storing, encoding or carrying instructions for execution by the machine, and includes digital or analog communications signals or other intangible medium to facilitate communication of such software.

Illustrative examples of various embodiments of the present disclosure are set forth below. Additional embodiments of the present disclosure are discussed in the preceding paragraphs. Accordingly, the scope of the present disclosure should not be construed as being limited to the following clauses:

Clause 1. A method comprising: defining, by at least one computing device, a complex curved surface a design tool; inputting, by the at least one computing device, a representation of the complex curbed surface to a script configured to translate the representation into a grid, wherein the grid corresponds to a plurality of inflatable pillows arranged into a pillow grid; determining, by the at least one computing device, an inflation height for each of the inflatable pillows from the pillow grid that corresponds to the representation of the complex curved surface; and causing, by the at least one computing device, the inflatable pillows from the pillow grid to be inflated to form the complex curved surface.

Clause 2. The method of clause 1, wherein the pillow grid comprises a plurality of cubic pillow installed onto a rigid backing.

Clause 3. The method of clause 1 or clause 2, wherein causing the inflatable pillow from the pillow grid to be inflated to form the complex curved surface further comprises causing a pneumatic system to provide air from an air compressor to respective ones of the pillow grid.

Clause 4. The method of any one of clauses 1 to 3, wherein the inflatable pillows from the pillow grid are constructed from a clear vinyl sheet.

Clause 5. The method of clause 4, wherein the inflatable pillows are connected using mechanically sewn seams.

Clause 6. The method of any one of clauses 1 to 3, wherein the inflatable pillows are respectively sealed from other pillows from the pillow grid.

Clause 7. The method of clause 1, wherein the inflatable pillows are inflated via solenoid valves that are respectively connected to individual ones of the inflatable pillows from the pillow grid.

Clause 8. The method of clause 3, wherein the pneumatic system comprises a control pendant facilitating starting and stopping of inflation as directed by the at least one computing device.

Clause 9. A system, comprising: a pillow grid comprising a plurality of inflatable pillows, wherein the inflatable pillows are cuboid in shape and interconnected in a grid pattern; at least one computing device; a gas source coupled to a pneumatic system that is configured to individually supply gas to respective ones of the inflatable pillows; and at £ least one application executable on the at least one computing device, wherein, when executed the at least one application causes the at least one computing device to at least: define a complex curved surface a design tool; input a representation of the complex curbed surface to a script configured to translate the representation into a grid, wherein the grid corresponds to a plurality of inflatable pillows arranged into a pillow grid; determine an inflation height for each of the inflatable pillows from the pillow grid that corresponds to the representation of the complex curved surface; and cause the inflatable pillows from the pillow grid to be inflated to form the complex curved surface.

Clause 10. The system of clause 9, wherein the pillow grid comprises a plurality cuboid pillows installed onto a rigid backing on a first side of the pillow grid.

Clause 11. The system of clause 10, wherein second side of the pillow grid opposing the first side is coupled to a flexible sheet.

Clause 12. The system of any one of clauses 9 to 11, wherein causing the inflatable pillow from the pillow grid to be inflated to form the complex curved surface further comprises causing a pneumatic system to provide air from an air compressor to respective ones of the pillow grid.

Clause 13. The system of any one of clauses 9 to 12, wherein the inflatable pillows from the pillow grid are constructed from a clear vinyl sheet.

Clause 14. The system of clause 13, wherein the inflatable pillows are connected using mechanically sewn seams.

Clause 15. The system of any one of clauses 9 to 14, wherein the inflatable pillows are respectively sealed from other pillows from the pillow grid.

Clause 16. The system of any one of clauses 9 to 15, wherein the inflatable pillows are inflated via solenoid valves that are respectively connected to individual ones of the inflatable pillows from the pillow grid.

Clause 17. The system of clause 9, wherein the pneumatic system comprises a control pendant facilitating starting and stopping of inflation as directed by the at least one computing device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A method comprising:
defining, by at least one computing device, a complex curved surface a design tool;
inputting, by the at least one computing device, a representation of the complex curbed surface to a script configured to translate the representation into a grid, wherein the grid corresponds to a plurality of inflatable pillows arranged into a pillow grid;
determining, by the at least one computing device, an inflation height for each of the inflatable pillows from the pillow grid that corresponds to the representation of the complex curved surface; and
causing, by the at least one computing device, the inflatable pillows from the pillow grid to be inflated to form the complex curved surface.

2. The method of claim 1, wherein the pillow grid comprises a plurality of cubic pillow installed onto a rigid backing.

3. The method of claim 1 or claim 2, wherein causing the inflatable pillow from the pillow grid to be inflated to form the complex curved surface further comprises causing a pneumatic system to provide air from an air compressor to respective ones of the pillow grid.

4. The method of any one of claims 1 to 3, wherein the inflatable pillows from the pillow grid are constructed from a clear vinyl sheet.

5. The method of claim 4, wherein the inflatable pillows are connected using mechanically sewn seams.

6. The method of any one of claims 1 to 3, wherein the inflatable pillows are respectively sealed from other pillows from the pillow grid.

7. The method of claim 1, wherein the inflatable pillows are inflated via solenoid valves that are respectively connected to individual ones of the inflatable pillows from the pillow grid.

8. The method of claim 3, wherein the pneumatic system comprises a control pendant facilitating starting and stopping of inflation as directed by the at least one computing device.

9. A system, comprising:
a pillow grid comprising a plurality of inflatable pillows, wherein the inflatable pillows are cuboid in shape and interconnected in a grid pattern;
at least one computing device;
a gas source coupled to a pneumatic system that is configured to individually supply gas to respective ones of the inflatable pillows; and
at least one application executable on the at least one computing device, wherein, when executed the at least one application causes the at least one computing device to at least:
define a complex curved surface a design tool;
input a representation of the complex curbed surface to a script configured to translate the representation into a grid, wherein the grid corresponds to a plurality of inflatable pillows arranged into a pillow grid;
determine an inflation height for each of the inflatable pillows from the pillow grid that corresponds to the representation of the complex curved surface; and
cause the inflatable pillows from the pillow grid to be inflated to form the complex curved surface.

10. The system of claim 9, wherein the pillow grid comprises a plurality cuboid pillows installed onto a rigid backing on a first side of the pillow grid.

11. The system of claim 10, wherein second side of the pillow grid opposing the first side is coupled to a flexible sheet.

12. The system of any one of claims 9 to 11, wherein causing the inflatable pillow from the pillow grid to be inflated to form the complex curved surface further comprises causing a pneumatic system to provide air from an air compressor to respective ones of the pillow grid.

13. The system of any one of claims 9 to 12, wherein the inflatable pillows from the pillow grid are constructed from a clear vinyl sheet.

14. The system of claim 13, wherein the inflatable pillows are connected using mechanically sewn seams.

15. The system of any one of claims 9 to 14, wherein the inflatable pillows are respectively sealed from other pillows from the pillow grid.

16. The system of any one of claims 9 to 15, wherein the inflatable pillows are inflated via solenoid valves that are respectively connected to individual ones of the inflatable pillows from the pillow grid.

17. The system of claim 9, wherein the pneumatic system comprises a control pendant facilitating starting and stopping of inflation as directed by the at least one computing device.
